(19) United States
(12) Patent Application Publication
(10) Pub. No.: US 2011/0053103 A1
(43) Pub. Date: Mar. 3, 2011

(54) Torch

(75) Inventors: Thomas A. Burdsall, Huntersville, NC (US); Norman Leblanc, Davidson, NC (US)

(73) Assignee: IRWIN INDUSTRIAL TOOL COMPANY, Huntersville, NC (US)

(21) Appl. No.: 12/857,055

(22) Filed: Aug. 16, 2010

Related U.S. Application Data
(60) Provisional application No. 61/236,720, filed on Aug. 25, 2009.

(51) Int. Cl. F23Q 7/00; F23D 99/00; B23P 19/04

(52) U.S. Cl. 431/254; 431/353; 29/428

(57) ABSTRACT

A torch and a burn tube for a torch are provided. The torch comprises a burn tube having a first end and a second end remote from the firsts end secured to a torch body for receiving a fuel. The first end has an orifice through which a flame is discharged. The burn tube is one-piece from the first end to the second end. The burn tube has an expanded portion located adjacent to the first end and a flame guide located entirely inside of the burn tube adjacent the first end. A method of making the burn tube and torch is also provided.

This application claims benefit of priority under 35 U.S.C. §119(e) to the filing date of to U.S. Provisional Application No. 61/236,720, as filed on Aug. 28, 2009, which is incorporated herein by reference in its entirety.

### BACKGROUND

The invention relates to torches and lighters such as propane, butane, mixed gas or MAPP fueled torches and butane lighters that use a source of fuel that may be ignited by a spark (collectively a “torch”). Self-igniting torches generate the spark using, for example, a piezoelectric igniter. Self-igniting torches and lighters typically include a trigger or push button ignition that when depressed activates the igniter to create a spark that ignites the fuel in the burn tube. Activation of the trigger may also release a flow of fuel under pressure into a burn tube or the release of fuel may be controlled by a separate control. The ignited fuel creates a flame at the end of the burn tube that can be used in a variety of heating/lighting applications. Such torches may be used for heating, brazing, welding and the like and for lighting a fire.

### SUMMARY OF THE INVENTION

A torch and a burn tube for a torch are provided. The torch comprises a burn tube having a first end having an orifice through which a flame is discharged and a second end remote from the first end and secured to a torch body for receiving a supply of fuel. The burn tube is one-piece from the first end to the second end. The burn tube has an enlarged or expanded portion located adjacent to the first end and a flame guide located entirely inside of the burn tube in or adjacent to the expanded portion.

The torch may include a valve for controlling the flow of fuel to the burn tube and a control for controlling the valve. The torch may also include an igniter for igniting the fuel in the burn tube such as a piezoelectric igniter. A trigger may be movably supported by the torch body to actuate the igniter. Conductors are provided for generating a spark in the burn tube adjacent the flame guide.

The burn tube may be stainless steel and the flame guide may be brass. The flame guide may be point staked to the burn tube. The flame guide may be positioned either in the non-expanded portion of the burn tube adjacent the expanded end or in the expanded end located adjacent the non-expanded portion of the burn tube.

A method of making a torch is also provided comprising forming a one-piece burn tube having a first diameter, a first end and a second end. A burn tip is formed in the burn tube by expanding the first end of the burn tube. A flame guide is located entirely within the burn tube adjacent the first end. The flame guide is secured to the burn tube such as by point staking. The first end of the burn tube may be crimped.

### BRIEF DESCRIPTION OF THE DRAWINGS

FIG. 1 is a perspective view of one embodiment of a torch.

FIG. 2 is a side view of the torch of FIG. 1 with a portion of the torch body removed to show the internal components of the torch.

FIG. 3 is an exploded view of the internal structure of one embodiment of a torch of the invention.

FIG. 4 is a perspective section view of an embodiment of the burn tube.

FIG. 5 is a perspective section view of another embodiment of the burn tube.

FIG. 6a through 6e illustrates the process of forming the burn tube.

FIG. 7 is a block diagram illustrating an embodiment of a method of making the burn tube and torch.

### DETAILED DESCRIPTION OF EMBODIMENTS OF THE INVENTION

A typical torch consists of a fuel source such as butane, propane, mixed gas, MAPP gas or other fuel held under pressure in a fuel container. The fuel container may be a tank or canister releasably connected to the torch body such that the fuel supply can be removed when empty and replaced. The fuel supply is connected to a fuel supply system that transports the fuel to a burn tube where it is ignited. In simpler and less expensive devices the fuel container, burn tube and fuel supply system may form part of an integrated device that may be disposed of after the fuel is depleted or the fuel container may be refilled.

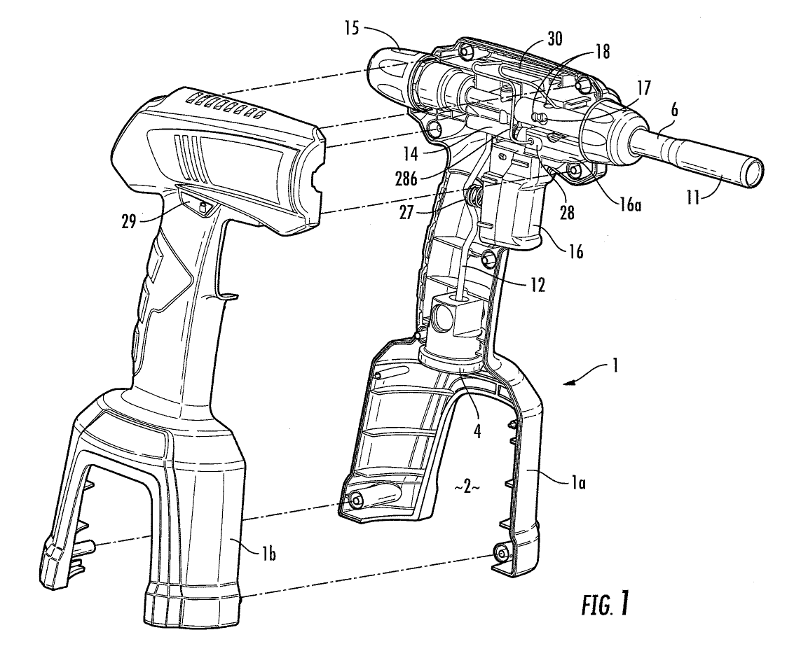

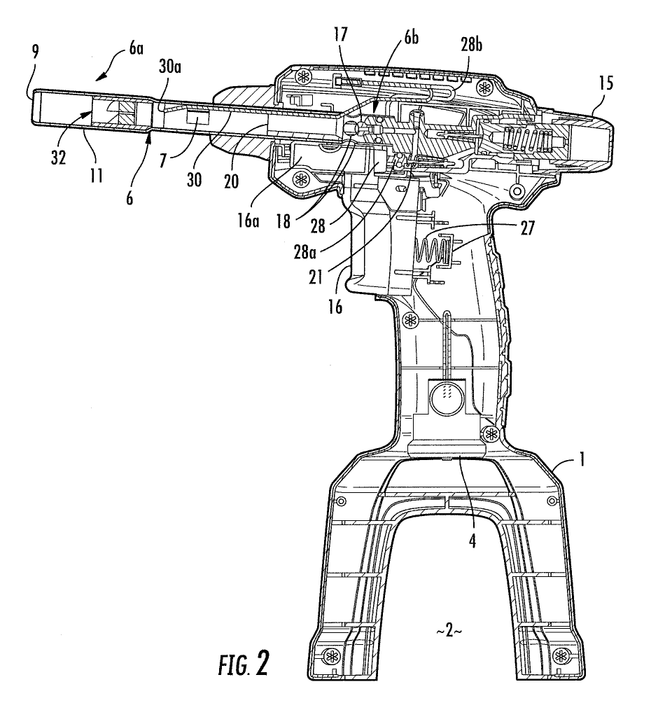

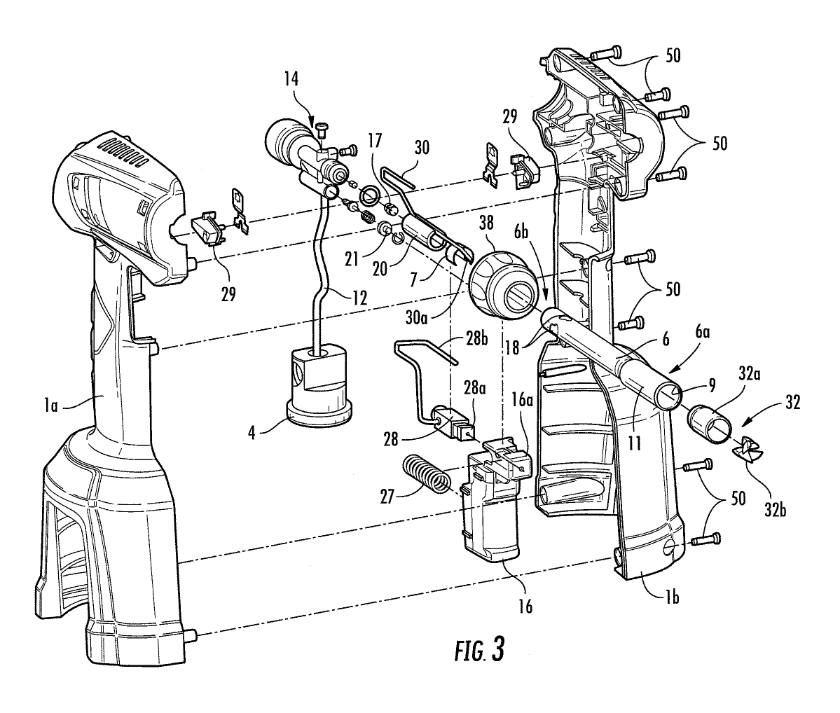

An example embodiment of a torch is shown in the FIGS. 1, 2 and 3 and comprises a torch body 1 made of plastic or other similar material. The torch body 1 may be made of two portions 1a and 1b joined together to create the finished body with the burn tube 6 trapped between the body portions and secured to the body 1. Gas such as propane or propylene (other fuels such as mixed gas, MAPP fuel, butane or the like may also be used) is delivered from a canister (not shown) that is secured to the body in open area 2. The fuel canister is connected to a coupler 4 such that an empty canister can be removed and replaced with a full canister. The fuel canister may be formed with screw threads or other releasable connector to connect the canister's inlet/outlet port to a mating connector on the coupler 4.

A typical fuel supply system for a torch may include a regulator for regulating the pressure of the fuel entering the fuel supply system; however, a regulator may not be required. In the illustrated embodiment the regulator is built into the gas valve assembly 14. The regulator may include a spring loaded diaphragm or piston, or other device that provides a flow of fuel under a constant pressure to avoid pressure variations that may occur due to variations in temperature, elevation or the like.

A fuel supply line 12 connects the coupler 4 to a gas valve assembly 14 such that the fuel is delivered via line 12 to the input port of the gas valve 14. The output port of the gas valve 14 is connected to an orifice 17 that delivers the fuel under pressure to one end of the burn tube 6. Apertures 18 are formed in the burn tube 6 adjacent orifice 17 such that air can be drawn into the burn tube and mixed with the fuel. A Venturi 20 may be provided in the burn tube to effectuate the mixing of the fuel and air. A manually actuated trigger 16 is used to open or close the gas valve 14 and control the flow of fuel to the burn tube 6. When trigger 26 is depressed, trigger 26 opens valve 14 to allow the fuel to flow into burn tube 6. A control knob 15 can be manipulated to control the size/heat of the flame generated by the torch.

To ignite the fuel and create a flame, trigger 16 actuates piezoelectric igniter 28 when the trigger is depressed such that a spark is created in the burn tube 6 to ignite the gas flowing through the burn tube. In the illustrated embodiment the igniter 28 is held in a chamber 16a formed in the trigger 16 such that the igniter 28 moves when the trigger is depressed. When the trigger 16 is depressed the igniter 28 is compressed between the end of chamber 16a and the valve stem 21 on the valve assembly 14 to depress the plunger 28a and actuate the igniter. The igniter 28 is actuated simultaneously or nearly simultaneously with the release of the fuel such that the flowing fuel is immediately ignited. A spring 27 returns the trigger 16 and igniter 28 to the extended position when the trigger is released. Other arrangements for actuating the igniter are also possible. A run-lock 29 that allows the torch to stay on even if the trigger is released may be provided to allow for hands-free operation of the torch.

To create the spark, igniter 28 has a first lead 28b that is connected to an electrical conductor 30. The electrical conductor 30 may include any electrically conductive element such as an insulated wire. Conductor 30 extends through one of apertures 18 and into the burn tube 6. The other lead of piezoelectric igniter 28 is connected to a second electrical conductor. The ends of the electrical conductors are spaced from one another such that when the igniter 28 is actuated a spark is generated between the conductors. In the present embodiment the burn tube 6 may be made of electrically conductive material and used as the second electrical conductor such that the spark is created between the end 30a of wire 30 and the interior surface of burn tube 6.

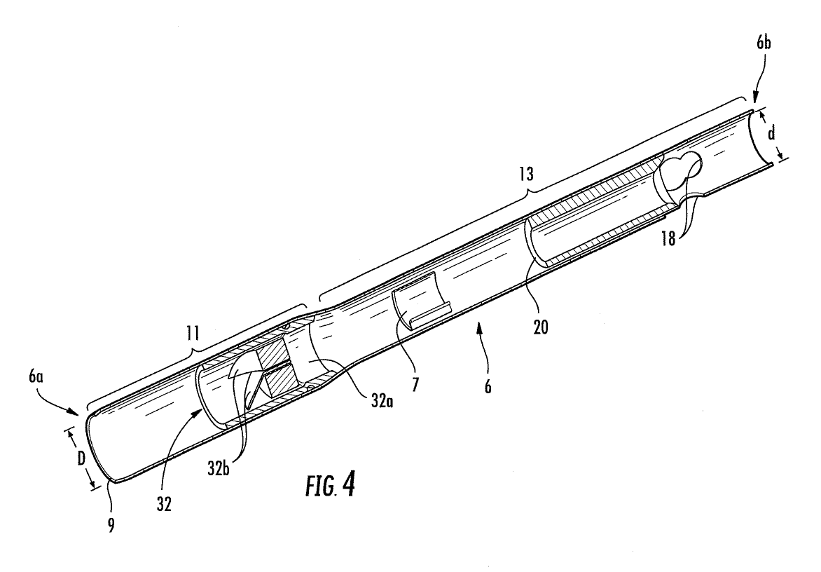

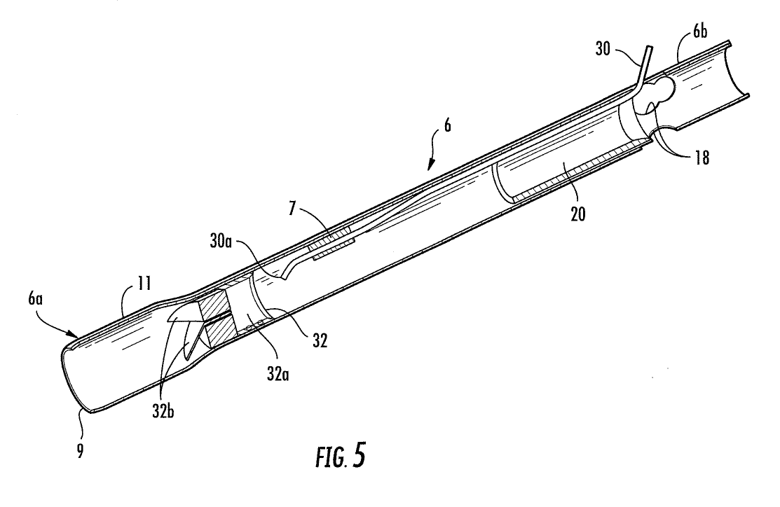

Referring to FIGS. 4 and 5, to create the spark in the burn tube 6, piezoelectric igniter 28 is actuated by depressing trigger 16. The end 30a of electrical conductor 30 is positioned in burn tube 6 such that it is spaced from the burn tube a distance such that arcing occurs between the end of the conductor 30a and the interior surface of burn tube 6 to create a spark that ignites the fuel/air mixture flowing through the burn tube. The conductor 32 may be supported in the burn tube 6 by a support 7. The end 30a of conductor 30 is located in the burn tube 6 toward the first end 6a of burn tube 6 such that the flame is generated near the opening 9 formed in the first end 6a of burn tube 6 and extends out of opening 9 a distance where it can be used for heating and lighting operations. The performance of a torch is based on the size and quality of the generated flame. Typically, a larger burn tube creates a larger flame with greater heat impact.

Burn tube 6 may be formed as a stainless steel tube that has an enlarged portion extending from opening 9 that forms burn tip 11. A separate component is positioned inside the tube as the flame guide. This structure duplicates the performance of more expensive torches without adding the cost of a large brass tip connected to the end of the tube. The same performance is achieved with fewer machining operations and less expensive materials because the stainless burn tube constructed as shown and described is less expensive than a burn tube having a brass tip connected to the end of a burn tube.

The burn tube 6 has a one-piece construction between the first end 6a and the second end 6b. The first end 6a includes opening 9 through which a flame is discharged. The second end 6b of burn tube 6 is supported in the body 1 and receives fuel flowing from orifice 17. In one embodiment the second end 6b fits over and closely engages orifice 17 such that fuel flows from orifice 17 into the second end 6b of burn tube 6. The first end 6a of the burn tube 6 is enlarged to create burn tip 11 that extends from the opening 9 for a portion of the total length of burn tube 6. Thus, the burn tip 11 is formed as an integral portion of the one-piece burn tube 6 having a larger diameter D than the diameter d of the remainder 13 of the burn tube 6. The enlarged burn tip 11 may be expanded from a smaller diameter tube. The enlarged burn tip 11 may be approximately one-third of the length of the burn tube 6. Further, the diameter D of the burn tip 11 may be expanded to be approximately 20 percent larger than the diameter d of the remainder of the burn tube. For example, a ½″ diameter (d) stainless steel burn tube 6 is expanded to have an enlarged burn tip 11 having a diameter (D) of approximately 0.600 inches where the expanded end extends for one-third of the total length of the tube 6.

A flame guide/holder 32 is inserted into the burn tube 6 and is fixed into place inside of burn tube 6. The flame guide 32 may be formed of a different material than the burn tube 6. In one embodiment the flame guide 32 is made of brass. The flame guide 32 may be positioned either in the enlarged diameter burn tip 11 located adjacent the smaller diameter portion of the burn tube 6 as shown in FIG. 4 or it may be positioned in the smaller diameter portion of the burn tube 6 just adjacent the enlarged diameter burn tip 11 as shown in FIG. 5. In either position some or all of the enlarged burn tip 11 extends beyond the flame guide/holder 32 and the flame guide/holder 32 is located downstream of the point where the spark is generated.

The flame guide/holder 32 is used to create a smaller, tighter flame that is more stable. The flame guide/holder 32 has a cylindrical portion 32a that is dimensioned to be closely received inside of burn tube 6. The flame guide/holder is fixed within burn tube 6 in the desired position. In one embodiment the cylindrical portion 32a is point staked to the interior wall of the burn tube 6. A plurality of vanes 32b are located in the flame guide/holder to create passages through which the flame passes. The vanes 32b create a vortex as the flame moves through the flame guide/holder 32 to mix the primary and secondary flames together. This mixing creates a smaller and tighter flame producing a higher heat concentration on the work piece. The mixing of the primary and secondary flames also burns the fuel more efficiently by mixing the secondary flame into the primary flame such that the secondary flame is not wasted.

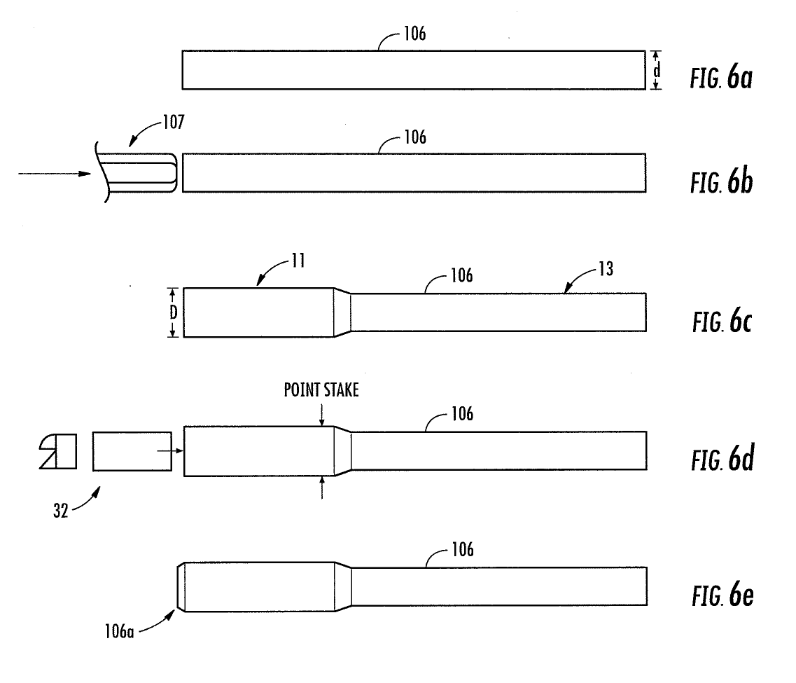

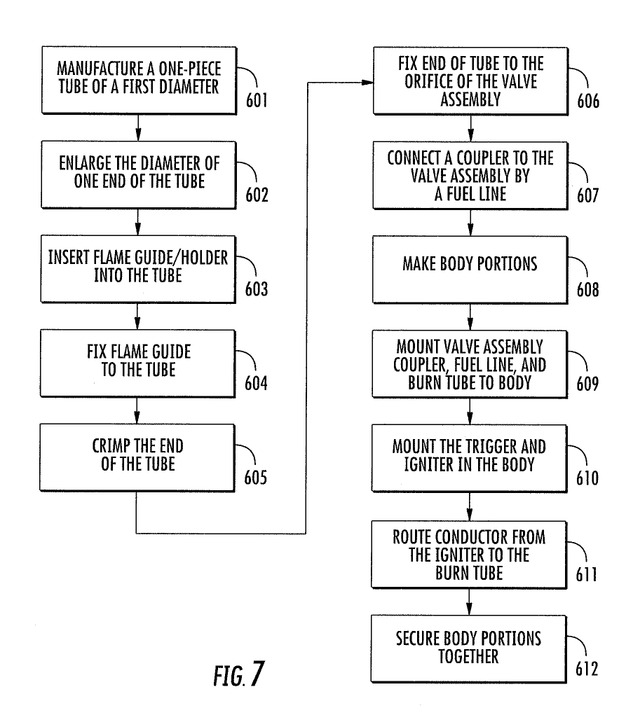

Referring to FIGS. 6 and 7, to manufacture the burn tube 6, a one-piece tube 106 is formed having a first diameter d, FIG. 6a (block 601). In one embodiment the burn tube is formed of stainless steel. The enlarged burn tip 11 is formed by expanding the first end of the burn tube (block 602) using an expanding collet or tapered mandrel 107, FIG. 6b. The expanded burn tip 11 having a second larger diameter D and the remainder 13 of the burn tube are formed as an integral, one-piece element, FIG. 6c. The flame guide/holder 32 is inserted into the enlarged burn tip 7 (block 603) and fixed to the burn tube such as by point staking the flame guide to the burn tube (block 604), FIG. 6d. The end 106a of the burn tip may be crimped around opening 9, FIG. 6e (block 605).

To manufacture a torch, collar 38 is fit over the second end 6b of the completed burn tube 6 and the second end is fit over and connected to the orifice 16 of valve assembly 14 such as by point staking (block 606). The coupler 4 is connected to the valve assembly 14 by fuel line 12 (block 607).

The body portions 1a and 1b are molded of plastic or formed of another rigid material (block 608). The valve assembly 14, fuel line 12, coupler 4 and burn tube 6 are mounted in one of the body portions 1a, 1b (block 609). The igniter is mounted in the trigger 16 and the trigger is mounted in one of the body portion 1a, 1b (block 610). The igniter conductor 30 is routed from igniter 28 through the burn tube with the end 30a of the conductor wire located adjacent the flame guide 32 (block 611). The body portions 1a and 1b are secured together such as by fasteners 50 trapping the components in the body 1 (block 612).

The construction of the burn tube 6 provides enhanced performance with fewer components, less expensive materials and fewer machining operations than existing torches. One measure of performance is the time it takes to solder a copper joint. A torch as described herein using a ½″ burn tube was tested and its performance was comparable to or better than torches with more expensive burn tubes of the same size made of brass and stainless steel.

While embodiments of the invention are disclosed herein, various changes and modifications can be made without departing from the spirit and scope of the invention as set forth in the claims. One of ordinary skill in the art will recognize that the invention has other applications in other environments. Many embodiments are possible. The following claims are in no way intended to limit the scope of the invention to the specific embodiments described above.

1. A torch comprising:
a burn tube having a first end having an opening through which a flame is discharged and a second end spaced from the first end, said burn tube being one-piece from the first end to the second end;
said burn tube having an enlarged portion located at said first end; and
a flame guide located entirely inside of the burn tube adjacent to the enlarged portion.

2. The torch of claim 1 further including a valve for controlling the flow of fuel to said burn tube.

3. The torch of claim 2 further including a control for controlling said valve.

4. The torch of claim 1 further including an igniter for igniting the fuel in the burn tube.

5. The torch of claim 4 wherein said igniter is a piezoelectric igniter.

6. The torch of claim 4 wherein a trigger is movably supported by said body, said trigger actuating said igniter.

7. The torch of claim 4 further including an electrical conductor connected to said igniter such that when the igniter is actuated a spark is generated by the conductor.

8. The torch of claim 7 wherein the spark is created between the burn tube and the conductor adjacent the flame guide.

9. The torch of claim 1 wherein said burn tube is stainless steel.

10. The torch of claim 1 wherein said flame guide is brass.

11. The torch of claim 10 wherein the flame guide is staked to said burn tube.

12. The torch of claim 1 wherein the flame guide is positioned in a non-enlarged portion of the burn tube adjacent the enlarged portion.

13. The torch of claim 1 wherein the flame guide is positioned in the enlarged portion located adjacent a non-enlarged portion of the burn tube.

14. A burn tube for use in a torch comprising:
an integral, one-piece tube having a first end having an opening through which a flame is to be discharged and a second end remote from said first end adapted to receive a fuel;
said burn tube having a larger diameter portion located adjacent to said first end and a smaller diameter portion; and
a flame guide located entirely inside of the burn tube adjacent.

15. The burn tube of claim 14 wherein said tube is stainless steel.

16. The burn tube of claim 14 wherein said flame guide is brass.

17. The burn tube of claim 14 wherein the flame guide is staked to said tube.

18. The burn tube of claim 14 wherein the flame guide is positioned in the smaller diameter portion of the tube adjacent the larger diameter portion.

19. The burn tube of claim 14 wherein the flame guide is positioned in the larger diameter portion located adjacent to the smaller diameter portion of the burn tube.

20. A method of making a torch comprising:
forming a one-piece burn tube having a first diameter, a first end and a second end;
expanding a burn tip by expanding the first end of the burn tube to a second larger diameter; and
securing a flame guide entirely within said burn tube adjacent said first end.

21. The torch of claim 20 wherein said flame guide is staked to said burn tube.

22. The torch of claim 20 further crimping the second end of the burn tube.
